(19) United States
(12) Patent Application Publication
(10) Pub. No.: US 2017/0249765 A1
(43) Pub. Date: Aug. 31, 2017

(54) IMAGE GENERATOR FOR LOCATION BASED ARRANGEMENTS OF ELEMENTS

(71) Applicant: Wal-Mart Stores, Inc., Bentonville, AR (US)

(72) Inventors: Shravan Hari, Bentonville, AR (US); Nikhil Varughese Cherian, Bentonville, AR (US); Peter Matthew Rowe, Bentonville, AR (US)

(21) Appl. No.: 15/439,448

(22) Filed: Feb. 22, 2017

Related U.S. Application Data
(60) Provisional application No. 62/300,319, filed on Feb. 26, 2016.

(51) Int. Cl. G06T 11/60; G06F 17/21

(52) U.S. Cl. CPC G06T 11/60; G06F 17/211; G06Q 10/087

(57) ABSTRACT

Described in detail herein are methods, systems, and computer-readable media associated with generation of a two-dimensional image of the object including an arrangement of elements within the object. In exemplary embodiments, the system may receive input containing data related to an object. The system may extract data regarding elements associated with the object and query data regarding sub-elements associated with the elements. The system may determine an affinity based on the received data associated with the elements and sub-elements and run multiple iterations of regression models to generate a comma separated flat file containing the elements and coordinates for the elements' arrangement. The system may convert the comma separated flat file into a two-dimensional image of the object including the arrangement of the elements, while the coordinates from the flat file provide the positioning of the elements in the two-dimensional image.

### CROSS-REFERENCE TO RELATED PATENT APPLICATIONS

This application is claims priority to U.S. Provisional Application No. 62/300,319 filed on Feb. 26, 2016, the content of which is hereby incorporated by reference in its entirety.

### BACKGROUND

It can be difficult to envision or otherwise specify locations for elements in an arrangement. This is particularly true when there are constraints as to locations where the elements can be placed in an arrangement.

### BRIEF DESCRIPTION OF DRAWINGS

Illustrative embodiments are shown by way of example in the accompanying drawings and should not be considered as a limitation of the present disclosure:

FIG. 1 illustrates an exemplary network environment of a computing system in accordance with exemplary embodiments of the present disclosure;

FIG. 2 is a block diagram of an example computing system for implementing exemplary embodiments of the present disclosure;

FIG. 3 is a block diagram that illustrates example data flow for creating a two- dimensional image file in accordance with exemplary embodiments of the present disclosure;

FIG. 4 illustrates a model according to exemplary embodiments of the present disclosure;

FIG. 5 illustrates a sample two-dimensional image file after according to exemplary embodiments of the present disclosure; and

FIG. 6 is a flowchart illustrating producing a two-dimensional image including the arrangement of elements according to exemplary embodiments of the present disclosure.

### DETAILED DESCRIPTION

Described in detail herein are methods, systems, and computer-readable media associated with generation of two-dimensional images of the objects including arrangements of elements within the objects. In exemplary embodiments, object data related to an object can be input and element data regarding elements associated with the object can be extracted from the object data. Using the element data, one or more queries to one or more databases can be created to retrieve sub-element data regarding one or more sub-elements associated with the elements.

Embodiments of the system can determine an affinity associated with the elements and sub-elements based on the element data and/or the sub-element data, and can execute multiple iterations of one or more regression models to generate a text file containing text strings associated with the element data as well as text strings for coordinates for the element data. For example, the one or more regression models can be executed to determine the coordinates for the elements based on one or more constraints and/or based on the affinity between the element data and/or the sub-element data. In some embodiments, the text file can be a comma separate flat file that uses commas to demarcate the text strings for the element data and coordinates. Embodiments of the system can generate image file including a two-dimensional image of the object based one the text file. For example, in some embodiments, the system can convert the comma separated flat file into a two-dimensional image of the object including a visual arrangement of the elements in the object based on the coordinates in the flat file.

In accordance with embodiments of the present disclosure, a system and method for creating a two-dimensional image can include one or more data storage devices including a non-transitory computer-readable media storing one or more data sources and a computing system including one or more servers having one or more processors communicatively coupled to the one or more data storage devices through a network to facilitate communication between the one or more processors and the one or more data sources. In exemplary embodiments, the computing system can be programmed to receive input (e.g., a first flat file) including object data associated with an object to be visualized, extract, from the object data, element data associated with elements to be associated with the object to be visualized, query the one more data sources for sub-element data associated with sub-elements of elements. The computer system can be further programmed to determine affinities between the elements and/or sub-elements, execute regression models utilizing the element data, the sub-element data, the affinities, and one or more constraints, and create a two-dimensional image representing the object that include graphical representations of the elements in an arrangement defined in response to execution of the regression models.

According to exemplary embodiments, in response to executing the regression models, the computing system can creates a second flat file based on an outcome of the execution of the regression models. The second flat file can include strings of alphanumeric characters.

According to exemplary embodiments, the two-dimensional image can be created by converting the strings of alphanumeric characters in the second flat file into the graphical representations of the elements in the two-dimensional image arranged according to a coordinate system, where the coordinates can be specified in the second flat file.

According exemplary embodiments, the constraints utilized by the regression models can include, for example, location based constraints, adjacency based constraints, angle constraints, affinity constraints, and/or logical constraints.

The following description is presented to enable any person skilled in the art to create two-dimensional image files that can be viewed to visually depict an arrangement of elements within an object based on results of a regression model. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that example embodiments of the present disclosure may be practiced without the use of these specific details. In other instances, well-known structures and processes are shown in block diagram form in order not to obscure the description of example embodiments with unnecessary detail. Thus, the present disclosure is not intended to be limited to the embodiments shown, but is to be accorded the widest scope consistent with the principles and features disclosed herein.

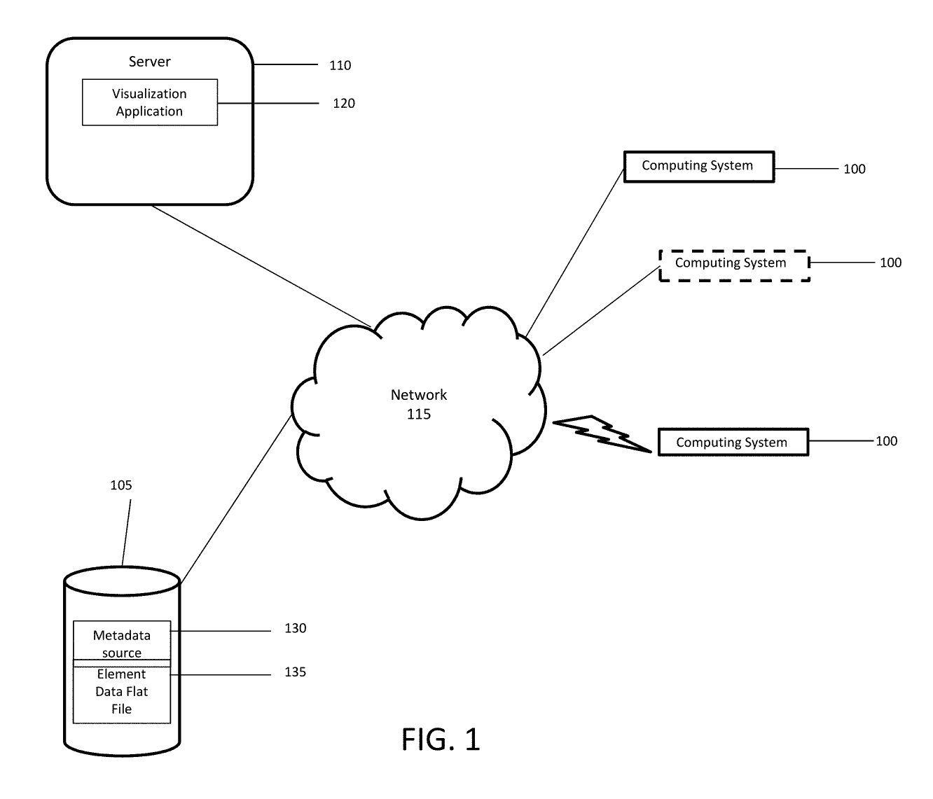

FIG. 1 illustrates an exemplary network environment of a computing system 100 according to exemplary embodiments. In exemplary embodiments, the computing system 100 is in communication with data sources 105 and a server 110 via a communications network 115.

In an example embodiment, one or more portions of communications network 115 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 110 and the data source 105 are connected to the network 115 via a wired connection. Alternatively, the server 110 and the data source 105 can be connected to the network 115 via a wireless connection. The server 110 includes one or more computers or processors configured to communicate with the computing system 100 and the data source 105, via the network 115. The server 110 hosts one or more applications configured to interact with one or more components computing system 100 and/or facilitates access to the content of the data source 105. The data source 105 may store information/data, as described herein. For example, the data source 105 may include a metadata source 130 and element data flat files 135. Each of the element data flat files 135 can be a comma separated file including element data associated with specific element that can be used to from an object to be visualized. The element data in each of the element data flat files 135 can include, for example, location constraints, an element size (e.g., footprint), sub-element data, element type data, and/or element format data. The metadata source 130 may include metadata corresponding to various elements within the object and sub-elements associated with sub-element data identified in the element data flat file 135. The data source 105 can include one or more storage devices for storing the sales data source, the flat files 135, instructions (or code) for use by the server 110 and the computing system 100, and/or any other suitable data or instructions for implementing embodiments of the present disclosure. The data source 105 and server 110 can be located at one or more geographically distributed locations from each other or from the computing system 100. Alternatively, the data source 105 can be included within server 110.

In some embodiments, the server 100 hosts an application. In exemplary embodiments, the server 110 can execute one or more instances of the visualization application 120 residing on the server 110 to facilitate retrieval of element data, metadata, define affinity data, generate one or more regression models based on the retrieved data, generating a second flat file containing alphanumeric characters, and generating a two-dimensional image including a graphical representation of an elements within an object.

The visualization application 120 can receive input regarding data associated with an object. The input may include object size, type, location, and format. The visualization application 120 may extract, from the element flat file 135, data associated with the plurality of elements or a specific element, to be associated with the object. The data may include, element constraints, element size data, sub-elements associated, element type data, and element format data. The visualization application 120 can query the metadata 130 for data associated with a plurality of sub-elements associated with each element within the object. The visualization application 120 may determine an affinity of the elements within the object.

The visualization application 120 may execute regression models associated with elements, the affinity of the of the elements and sub-elements, and constraints. In exemplary embodiments, the visualization application 120 may execute multiple iterations of the regression models based on variations of the constraints. The visualization model 120 may create a second flat file based on the execution of the regression models. The second flat file may be a comma separated file containing alphanumeric characters. The alphanumeric characters may represent multiple elements associated with objects and the coordinates of the multiple departments with respect to the object. The coordinates may represent an arrangement of the elements within the object based on the execution of the regression models. The visualization application 120 may convert the second flat file into a two-dimensional image file including graphical representation of an arrangement of the elements within the object. For example, the two-dimensional image file may be a layout of the object including different elements positioned in the object based on the regression models executed by the visualization application 120. In exemplary embodiments, the visualization application 120 may use the coordinates from the second flat file to position the elements with respects to the object in the correct location in the two-dimensional image file.

In a non-limiting example, the object may be a retail store, the elements may be various departments within the retail store, and the sub-elements maybe items within the departments. The visualization application 120 may receive input associated with a retail store. The input may include retail store size, format, and location. The visualization application 120 may query the metadata source 130 for sales data associated with the retail store and the department and items within the retail store. The visualization application 120 may also extract department data for a specific department from the element flat file 135. The element flat file 135 may include, department constraints, department size data, department item data, department type data, and department format data. The constraints may be logical constraints, physical constraints, legal constraints, angle constraints and business constraints. The visualization application 120 may run a first iteration of a regression model based on the retail store data, sales data and the department data extracted from the element flat file 135. The visualization application 120 may calculate the affinity of various departments within the retail store. The affinity includes an index that represents the actual rate at which two departments or categories sell together relative to their expected rate of sale.

The visualization application 120 may run several iterations of the regression model using the affinity calculation and adjusted constraints. The visualization application 120 may generate a comma separated second flat file. The second flat file may contain alpha numeric characters representing the positions of the various departments throughout the retail store. The second flat file may contain coordinates for the departments with respect to the layout of the retail store. The data in the second flat file may represent a recommended layout for the retail store. The visualization application 120 may generate a two-dimensional image file depicting a visual layout of the retail store using the second flat file. The two-dimensional image file may be a blueprint of the retail store or a map of the retail store. The visualization application 120 may use the coordinates from the second flat file to accurately position the departments within the facility in the two-dimensional image file.

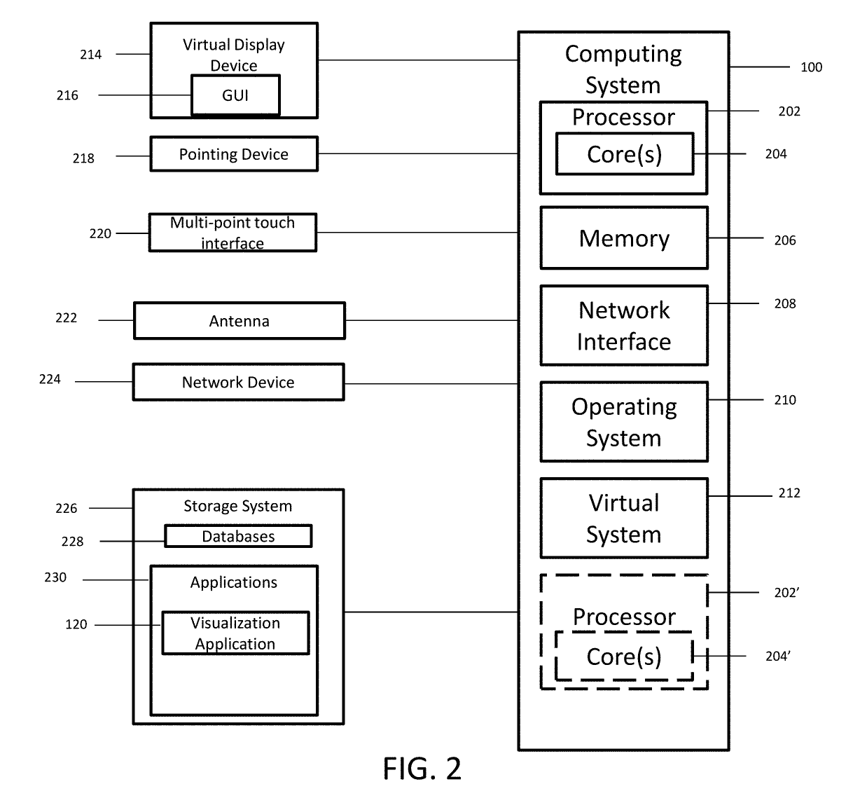

FIG. 2 is a block diagram of an example computing system for implementing exemplary embodiments of the present disclosure. The computing system 100 includes one or more non- transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 206 included in the computing system 100 may store computer-readable and computer-executable instructions or software (e.g., applications 230) for implementing exemplary operations of the computing system 100. The computing device 100 also includes configurable and/or programmable processor 202 and associated core(s) 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for implementing exemplary embodiments of the present disclosure. Processor 202 and processor(s) 202′ may each be a single core processor or multiple core (204 and 204′) processor.

Virtualization may be employed in the computing system 100 so that infrastructure and resources in the computing system 100 may be shared dynamically. A virtual machine 212 may be provided to handle a process running on multiple processors so that the process appears to be using only one computing resource rather than multiple computing resources. Multiple virtual machines may also be used with one processor.

Memory 206 may include a computer system memory or random access memory, such as DRAM, SRAM, EDO RAM, and the like. Memory 206 may include other types of memory as well, or combinations thereof.

A user may interact with the computing system 100 through a visual display device 214, such as a computer monitor, which may display one or more graphical user interfaces 216, multi touch interface 220, and a pointing device 218.

The computing system 100 may also include one or more storage devices 226, such as a hard-drive, CD-ROM, or other computer readable media, for storing data and computer-readable instructions and/or software that implement exemplary embodiments of the present disclosure (e.g., applications). For example, the one or more storage devices 226 can store the visualization application 120, which can be executed by the processor 202 of the computer device 200, and/or can include a client-side application for access and interacting with the visualization application 120 hosted by a server (e.g., the server 110 shown in FIG. 1). The one or more databases 228 can store any suitable information required to implement exemplary embodiments. For example, exemplary storage device 226 can include one or more databases 228 for storing information, such as the metadata source 130 and the element data flat file 135. The databases 228 may be updated manually or automatically at any suitable time to add, delete, and/or update one or more data items in the databases.

The computing system 100 can include a network interface 208 configured to interface via one or more network devices 224 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 222 to facilitate wireless communication (e.g., via the network interface) between the computing system 100 and a network and/or between the computing device 100 and other computing devices. The network interface 208 may include a built-in network adapter, network interface card, PCMCIA network card, card bus network adapter, wireless network adapter, USB network adapter, modem or any other device suitable for interfacing the computing device 100 to any type of network capable of communication and performing the operations described herein.

The computing system 100 may run any operating system 210, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 200 and performing the operations described herein. In exemplary embodiments, the operating system 210 may be run in native mode or emulated mode. In an exemplary embodiment, the operating system 210 may be run on one or more cloud machine instances.

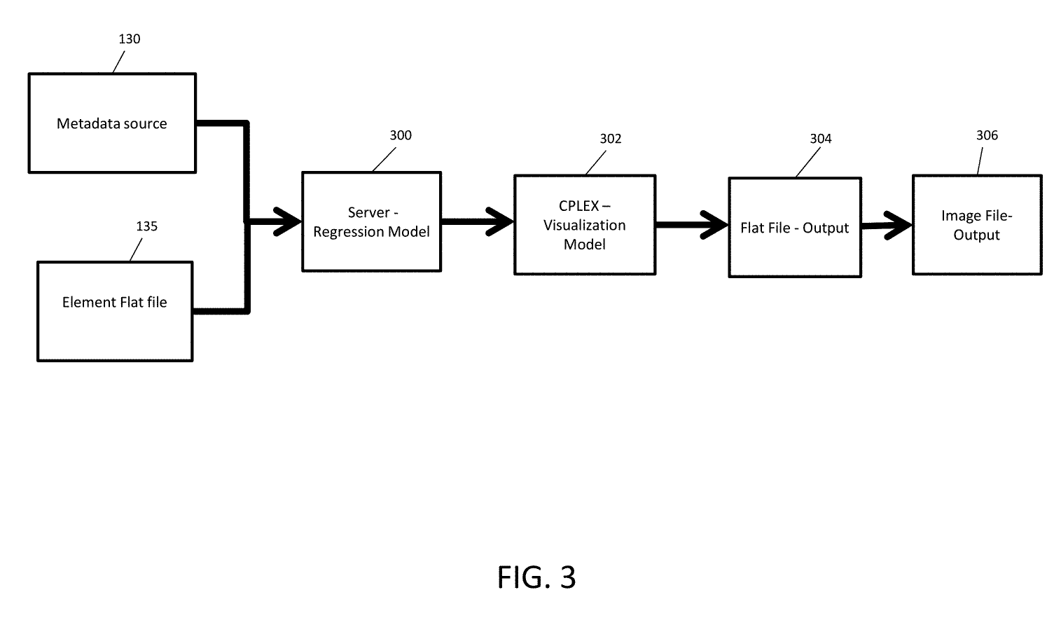

FIG. 3 is a block diagram that illustrates example data flow for creating an two-dimensional image file in accordance with exemplary embodiments of the present disclosure. In exemplary embodiments, the visualization application 120 (as shown in FIG. 1) extracts data from the element data flat file 135. The visualization application 120 may use Teradata to extract the data from the department data flat file 135. The visualization application 120 can also query the metadata source 130 for data for a particular object associated with the elements. The visualization application 120 may also receive input associated with data about the object. The data may include object size, location and type.

The visualization application 120 may input the element data, metadata, and object data into an initial iteration of a regression model 300. The visualization application 120 may produce resultant data from the first iteration of the regression model 300. The resultant data may represent an initial arrangement of the elements within the object. The visualization application 120 may receive further constraints for the resultant data. The visualization application 120 may calculate affinity data for the elements. Based on the new constraints and calculated affinity the visualization application 120 may run a final iteration of the regression model also known as the visualization model 302.

The visualization model 302 may produce a second flat file 304. The second flat file 304 may be a comma separated file containing alphanumeric characters. The alphanumeric characters may represent multiple departments of a retail store and the coordinates of the elements with respect to the object. The coordinates may represent an arrangement of the elements within the retail store based on the execution of the regression models.

The visualization application 120 may convert the second flat file 304 into a two-dimensional image file 306 including graphical representation of an arrangement of the departments within the retail store. For example, the two-dimensional image file 306 may be a layout of the retail store including different departments positioned in the retail store based on the regression models executed by the visualization application 120. In exemplary embodiments, the visualization application 120 may use the coordinates from the second flat file 304 to position the departments in the correct location in the two-dimensional image file 306. In exemplary embodiments, the two-dimensional image file may be a map, blueprint or layout of the retail store.

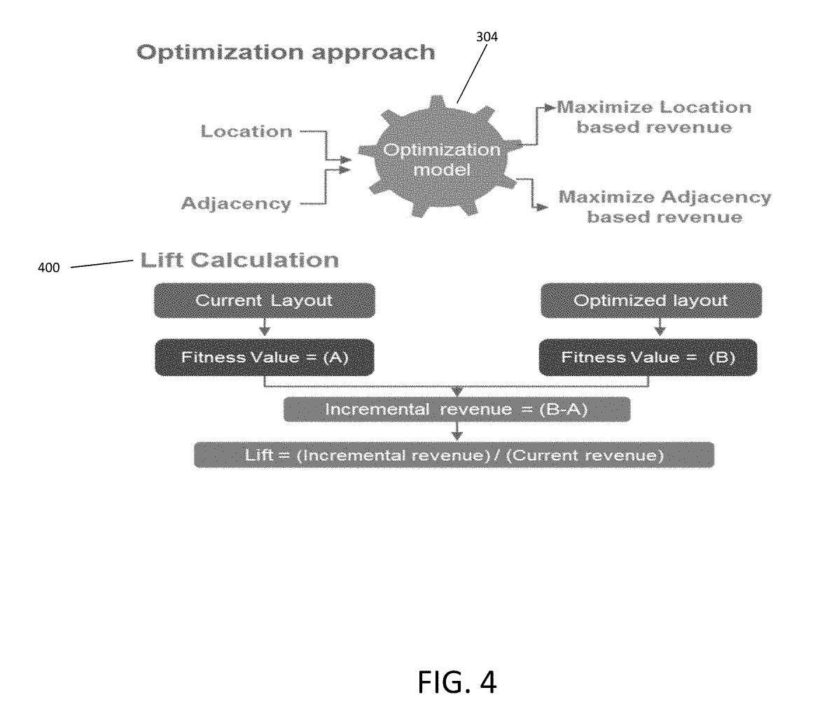

FIGS. 4-7 illustrate a non-limiting example of the implementation of the visualization application 120 (as shown in FIG. 1) generating a recommended layout for a retail store. In this example an object is a retail store, the elements are departments within the retail store and sub-elements are items within the departments.

FIG. 4 illustrates the visualization model according to exemplary embodiments of the present disclosure. In exemplary embodiments, the visualization model 302 (as shown in FIG. 3) may determine a recommended arrangement of the departments within the retail store. The visualization model 302 may calculate the departments' affinity to determine the arrangement of the departments. In order to calculate affinity the visualization model 302 may execute a lift calculation 400. In exemplary embodiments, the lift calculation 400 reflects the maximum location based revenue and the maximum adjacency based revenue. For example, the visualization model 302 may calculate in which areas of the retail store a particular department is generating the most revenue and which departments is the particular department adjacent to when generating the most revenue. The visualization model 302 may calculate a maximum sales lift based on the maximum location based revenue and the maximum adjacency based revenue. The visualization model 302 may calculate the maximum lift using the following equation:

Maximize Sales Lift_{TBX}=∫{Department Adjacency, Department Location} (1)

The maximum sales lift is subject to logical constraints, business constraints, physical constraints, and legal constraints. For example, even though a certain department may generate the most revenue adjacent to another department, the two departments may be legally restricted to be positioned next to each other, and consequently may be a legal constraint. The visualization model 302 may further calculate the maximum lift based on the current layout and the optimized layout. The optimized model 302 may calculate an incremental revenue based on the current layout and the optimized layout. The optimized model 302 may execute the lift calculation 400 based on the following equation:

Lift=(Incremental revenue)/(Current Revenue) (2)

Based on the calculated lift, the optimized model 302 may generate coordinates for the departments. The coordinates may represent the positioning of the departments within the retail store. The optimized model 302 may generate a second flat file 304 including the departments and the coordinates for the positioning of the departments within the retail store.

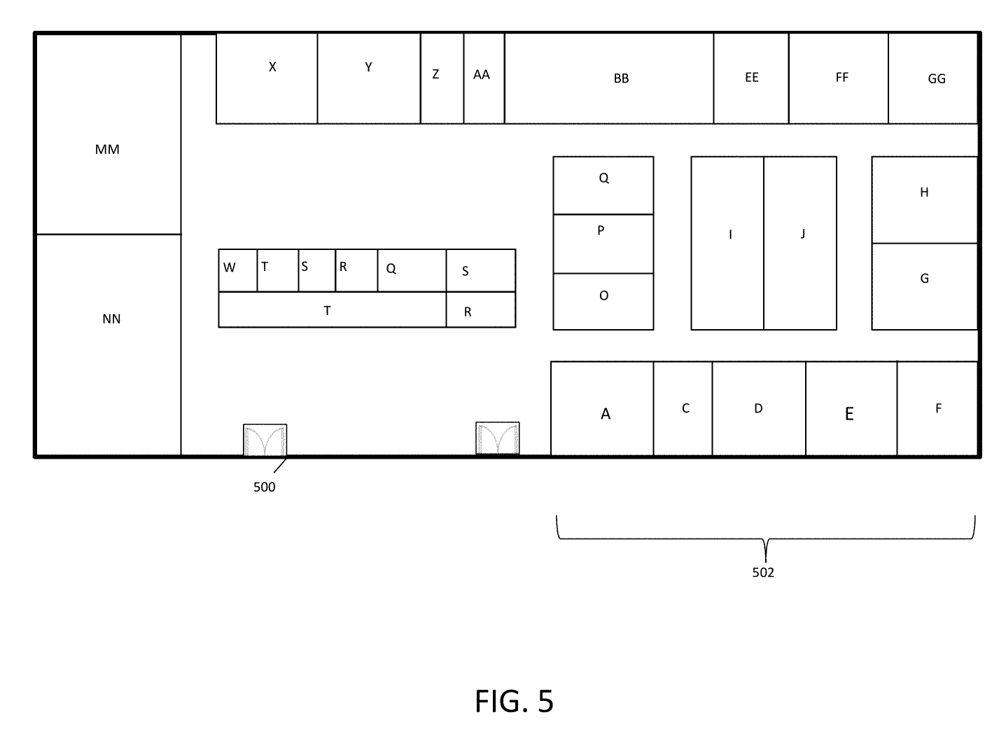

FIG. 5 illustrates an example two-dimensional image after the visualization process according to exemplary embodiments of the present disclosure. For example, the visualization application 120 (as shown in FIG. 1) may produce a two-dimensional image file illustrating the layout of the retail store including the arrangement of the departments based on the maximum lift calculation 400 as shown in FIG. 4. In exemplary embodiments, the two-dimensional image 500 may illustrate the layout of the retail store where a position of the different departments is determined at least in part by using the lift calculation 400. For example, in Department E is placed to the right side of Department D and the left side of Department F. The positioning of Department E may result an in an higher lift then the positioning shown based on the affinity to Departments D and F. The higher lift may cause higher revenue.

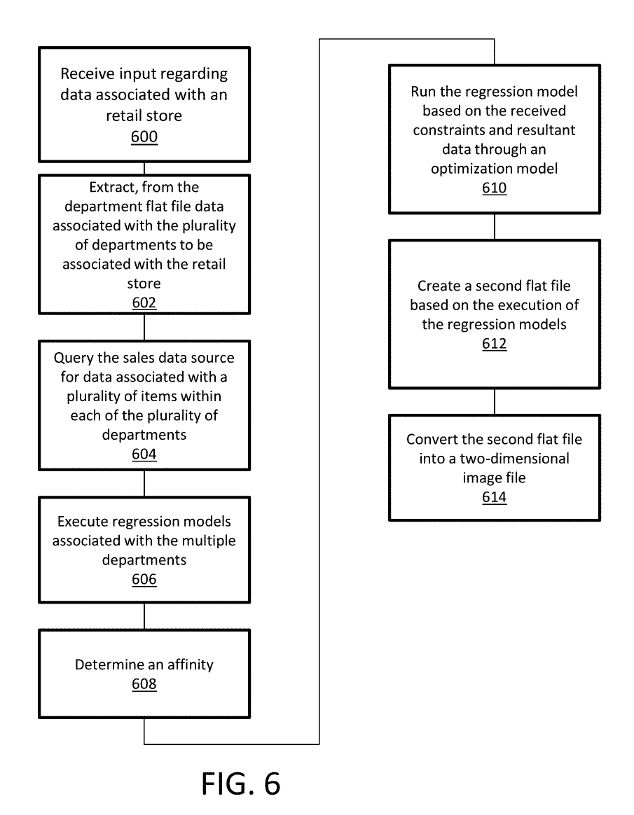

FIG. 6 is a flowchart illustrating producing an two-dimensional image including the arrangement of elements according to exemplary embodiments of the present disclosure. In exemplary embodiments, in operation 600 the visualization application 120 (as shown in FIG. 1) can receive input regarding data associated with a retail store. The input may include retail store size, type, location and format.

In operation 602, the visualization application 120 may extract, from the element flat file 135, data associated with the plurality of departments associated with the retail store. The data may include, department constraints, department size data, department item data, department type data, and department format data. In exemplary embodiments, the constraints may be logical constraints, physical constraints, legal constraints, angle constraints and business constraints.

In operation 604, the visualization application 120 can query the metadata source 130 for sales data associated with a plurality of be items within a department. The visualization application 120 may retrieve data associated with the items including sales data, revenue data and pricing data.

In operation 606, the visualization application 120 may execute regression models associated with the multiple departments, and constraints. In exemplary embodiments, the visualization application 120 may execute multiple iterations of the regression models based on variations of the constraints. The initial regression model iteration may generate resultant data. The visualization application 120 may receive further constraints for the resultant data. The constraints may be logical constraints, business constraints, legal constraints and physical constraints. For example, adjacency constraints may restrict certain departments to be adjacent to each other and angle constraints may restrict a department to be facing a certain angle in the retail store. In exemplary embodiments, the visualization model 302 (as shown in FIG. 3), may determine an optimized layout to uncover newer opportunities for each department while simultaneously minimizing conflicting scenarios between demand fulfillments of the departments using the constraints.

In operation 608, the visualization application 120 determine an affinity of the items between the multiple departments. In exemplary embodiments, the affinity includes an index that represents the actual rate at which two departments or categories sell together relative to their expected rate of sale.

In operation 610, the visualization application 120 may run a final iteration of the regression model based on the received constraints, affinity calculation and resultant data through an visualization model 302. The visualization model 302 may determine a recommended arrangement of the departments within the retail store using affinity visualization. Affinity is an index that represents the actual rate at which two departments or categories sell together relative to their expected rate of sale. Affinity may assist the visualization model 302 in determining which departments should be positioned next to each other. The visualization model 302 determine the affinity of the departments by executing a lift calculation 400 (as shown in FIG. 4) and determining a lift factor based on the constraints and resultant data. The lift factor may reflect the rise in revenue for a department based on a new position of the department in the retail store. The visualization model 302 may determine an arrangement of the departments based on the highest lift factor.

In operation 612, the visualization application 120 may create a second flat file based on the execution of the regression models. The second flat file may be a comma separated file containing alphanumeric characters. The alphanumeric characters may represent multiple departments of a retail store and the coordinates of the multiple departments with respect to the retail store. The coordinates may represent an arrangement of the departments within the retail store based on the execution of the regression models.

In operation 614, the visualization application 120 may convert the second flat file into a two-dimensional image file 500 including graphical representation of an arrangement of the departments within the retail store. For example, the two-dimensional image file 500 may be a layout of the retail store including different departments positioned in the retail store based on the regression models executed by the visualization application 120. In exemplary embodiments, the visualization application 120 may use the coordinates from the second flat file to position the departments in the correct location in the two-dimensional image 500 (as shown in FIG. 5).

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for creating a two-dimensional image, the system comprising:
one or more data storage devices including a non-transitory computer-readable medium storing a data source;
a computing system including a server having a processor communicatively coupled to the one or more data storage devices through a network to facilitate communication between the processor and the data source, the computing system programmed to:
receive input regarding data associated with an object;
extract, from a first flat file, data associated with a plurality of elements to be associated with the object;
query the data source for data associated with a plurality of sub-elements within each of the plurality of elements;
determine an affinity of the sub-elements between the plurality of elements;
execute regression models associated with the plurality of elements, the affinity of the sub-elements, and a plurality of constraints;
create a two-dimensional image representing the object, the two-dimensional image including graphical representations of the plurality of elements in an arrangement based on execution of the regression models.

2. The system in claim 1, wherein in response to executing the regression models, the computing system creates a second flat file based on the plurality of regression models associated with the plurality of elements, and a plurality of constraints, the second flat file including strings of alphanumeric characters.

3. The system in claim 2, wherein the two-dimensional image is created by converting the strings of alphanumeric characters in the second flat file into the graphical representations of the plurality of elements in the two-dimensional image.

4. The system in claim 2, wherein the strings of alphanumeric characters in the second flat file are separated by commas.

5. The system in claim 3, wherein the at least some of the strings of alphanumeric characters correspond to a coordinate system.

6. The system in claim 2, wherein the plurality of constraints include, location based constraints, adjacency based constraints, angle constraints, affinity constraints, and logical constraints.

7. A method for a suggested two-dimensional image corresponding to a layout of a facility, the method comprising:
receiving input regarding data associated with an object, via a computing system including a server having a processor communicatively coupled to one or more data storage devices through a network to facilitate communication between the processor and the data source, the computing system programmed to:
extracting, via the computing system, from a first flat file, data associated with at least one of a plurality of elements to be located within the object;
querying, via the computing system, the data source for data associated with a plurality of sub-elements within each of the plurality of sub-elements;
determining, via the computing system, an affinity of the sub-elements between the plurality of elements;
executing, via the computing system, regression models associated with the plurality of elements, the affinity of the sub-elements, and a plurality of constraints;
creating, via the computing system, a two-dimensional image representing the object, the two-dimensional image including graphical representations of the plurality of elements in an arrangement based on execution of the regression models.

8. The method in claim 7, further comprising in response to executing the regression models, creating, via the computing system, a second flat file based on the plurality of regression models associated with the plurality of elements, and a plurality of constraints, the second flat file including strings of alphanumeric characters.

9. The method in claim 8, wherein creating the two-dimensional image comprises converting the strings of alphanumeric characters in the second flat file into the graphical representations of the plurality of elements in the two-dimensional image.

10. The method in claim 8, wherein the strings of alphanumeric characters in the second flat file are separated by commas.

11. The method in claim 9, wherein at least some of the strings of alphanumeric characters correspond to a coordinate system.

12. The method in claim 8, wherein the plurality of constraints include, location based constraints, adjacency based constraints, angle constraints, affinity constraints and logical constraints.

13. A non-transitory computer readable memory medium storing instructions, wherein the instructions are executable by a processor to:
receive input regarding data associated with an object, via a computing system including a server having a processor communicatively coupled to one or more data storage devices through a network to facilitate communication between the processor and the data source, the computing system programmed to:
extract, via the computing system, from a first flat file, data associated with at least one of a plurality of elements to be located within the object;
query, via the computing system, the data source for data associated with a plurality of sub-elements within each of the plurality of sub-elements;
determine, via the computing system, an affinity of the sub-elements between the plurality of elements;
execute, via the computing system, regression models associated with the plurality of elements, the affinity of the sub-elements, and a plurality of constraints;
create, via the computing system, a two-dimensional image representing the object, the two-dimensional image including graphical representations of the plurality of elements in an arrangement based on execution of the regression models.

14. The non-transitory computer readable medium in claim 13, wherein in response to executing the regression models, execution of the instructions by the processor causes the processor to create a second flat file based on the plurality of regression models associated with the plurality of elements, and a plurality of constraints, the second flat file including strings of alphanumeric characters.

15. The non-transitory computer readable medium in claim 14, wherein the two-dimensional image is created by converting the strings of alphanumeric characters in the second flat file into the graphical representations of the plurality of elements in the two-dimensional image

16. The non-transitory computer readable medium in claim 14, wherein the strings of alphanumeric characters in the second flat file are separated by commas.

17. The non-transitory computer readable medium in claim 15, wherein at least some of the strings of alphanumeric characters correspond to a coordinate system.

18. The non-transitory computer readable medium in claim 14, wherein the plurality of constraints include, location based constraints, adjacency based constraints, angle constraints, affinity constraints and logical constraints.
